(19) United States
(12) Patent Application Publication
(10) Pub. No.: US 2015/0218457 A1
(43) Pub. Date: Aug. 6, 2015

(54) METHOD AND PLANT FOR PRODUCTION OF A FUEL GAS FROM WASTE

(71) Applicant: Jørn Jacobsen, Marbella (ES)

(72) Inventor: Jørn Jacobsen, Marbella (ES)

(21) Appl. No.: 14/410,219

(22) PCT Filed: Jul. 1, 2013
(86) PCT No.: PCT/EP2013/063868

§ 371 Date: Dec. 22, 2014

(30) Foreign Application Priority Data
Jun. 29, 2012 (EP) 12174397.5

(51) Int. Cl. C10B 57/02; C10B 53/07; C10K 1/10; B01D 53/22; C10K 1/00; C10B 27/00; C10B 53/02

(52) U.S. Cl. CPC C10B 57/02; C10B 27/00; C10B 53/07; C10B 53/02; B01D 53/229; C10K 1/005; C10K 1/10; B01D 2053/221

(57) ABSTRACT

A method and plant for thermal treatment and chemical transformation of waste comprising natural and synthetic carbonaceous materials for generation of a fuel gas for further use is described. Pyrolysis gas and solid waste from a thermolysis and pyrolysis reactor (40), is further processed to produce a fuel gas having a substantially stable WOBBE index.

### TECHNICAL FIELD

The present invention relates to handling of waste, more specifically waste mainly of organic origin such as biomass, municipal solid waste (MSW), plastic, rubber and the like. More specifically, the present invention relates to improvements in the conversion of said waste into a useful energy source, such as electrical power, or fuel.

### BACKGROUND ART

Domestic waste is a mixture materials, and comprises all from food, both covering food of animal and plant origin, paper and other products made of plant fibres, such as fabric, building material, both comprising wood and wood based products, plastic and concrete, natural and synthetic polymer materials, such as plastics of different kinds, rubber, synthetic rubber, metals, etc.

Traditionally, domestic waste and industry waste have been filled into landfills. Landfills take up valuable space, and create an aesthetical problem both with regard to the “visual pollution”, and the smell associated with the waste. An additional problem with landfills is poisonous and environmentally unacceptable compounds in gaseous form, or liquids or solids that are solubilised in liquids in the landfill. Gases released from the waste in a landfill may, in addition to result in unwanted smell, comprise poisonous and/or environmentally unacceptable gaseous compounds, such as Volatile Organic Compounds (or VOC) that will be released from the waste into the atmosphere. Liquids, either being a part of the waste, or water caused by rain, draining through the landfill, will solubilise solid compounds in the landfill, and will leak from the landfill, to pollute both surface water in streams, lakes, and may penetrate into the ground water

To avoid filling up all available space with landfills and to avoid the other problems associated therewith, plants for sorting of the waste have been built. Recyclable materials are separated from non-recyclable waste. The recyclable material is sent to plants to recover valuable materials, and recycle the materials, such metals. The non-recyclable materials may be separated into combustible materials and non-combustible materials. The non-combustible materials are sent to landfills or the like, whereas combustible materials are introduced into an incineration plant. In the incineration plant the combustible material is combusted at high temperature to destroy all temperature degradable or combustible material, including poisonous and environmentally unwanted compounds. Additionally, different means are included to avoid emission of hazardous gases from the incineration plant.

By the combustion the volume of the solid waste is reduced by from 50 to 90% dependent on the composition of the waste, and the combustion technology. The heat of combustion is often used for district heating and/or cooling.

Technology for sorting waste is well known. Normally, the waste is sorted based on their physical properties, such as magnetic properties, density, surface to weight, etc.

Incineration plants are also well known, and a large number of such plants are in operation.

EP 1160307 (KUNSTSTOFF-UND UMWELTSTECHNIK GMBH) May 12, 2001 relates to a method and plant for thermal treatment and chemical conversion of natural and synthetic compounds from waste to form a gas for further use. The composition of the product gas is not well defined, but the product gas seems to comprise a mixture of lower hydrocarbons, CO₂, CO, and hydrogen. Lower hydrocarbons are in the present description used mainly to encompass hydrocarbons that are gases at ambient temperatures, such as methane, ethane, propane and butane. It is indicated that the product gas is used a gas operated engine or turbine. It is; however, clear that the gas composition from the device according to EP 1160307 will vary as a function of the actual composition of the waste introduced into the device. Such variations make the gas unsuitable for a modern high efficient gas turbine, but are acceptable for gas operated engines that are far less efficient than a modern gas turbine. No other potential uses are indicated for the product gas.

The present invention is based on EP1160307 in that it uses the core technology described therein for pyrolysis and thermolysis of organic compounds. The present invention is directed to improvements allowing to obtain a product gas having a predetermined composition, mainly comprising hydrogen, CO, CO₂ and lower hydrocarbons adjusted to fit the intended use, and having a WOBBE index (Wobbe index=calorific value/(gas specific gravity)⁻²), that is substantially constant over time.

Especially when the intended use for the produced gas is as fuel for a gas turbine, it is important to ascertain a constant WOBBE index fulfilling the requirements of a modern efficient gas turbine, i.e. that the fluctuations in the WOBBE index is less than 2% over a period of 10 minutes. The composition of the produced gas having high hydrogen content, resulting in a high temperature flame, makes it especially important to keep the WOBBE index substantially constant.

### SUMMARY OF INVENTION

According to a first aspect, the present invention relates to a method for thermal treatment and chemical transformation of waste comprising natural and synthetic carbonaceous materials for generation of a fuel gas for further use, the method comprising the following steps:
a. adjusting the humidity of the carbonaceous materials to a predetermined level by drying or introduction of water or steam into the carbonaceous material,
b. introduction of the humidified carbonaceous material into thermolysis and pyrolysis reactor(s), in which the materials are thermally treated to produce a raw pyrolysis and thermolysis gas and a carbonaceous solid rest,
c. introduction of the carbonaceous solid rest from step b) and steam into a conversion unit to cause partial gasification of solid carbonaceous material therein to produce a synthesis gas comprising hydrogen, CO and CO₂ that is withdrawn and introduced into a second scrubbing section and a solid rest that is withdrawn for further treatment or disposal,
d. introducing the raw thermolysis and pyrolysis gas from step b) into a first gas cleaning unit where the gas is separated into a first light oil fraction having a boiling range from 170 to 350° C. at atmospheric pressure, and a scrubbed raw gas fraction mainly comprising H, CO, CO₂ and hydrocarbons having a boiling range below 170° C.,
e. introducing the scrubbed raw gas fraction into a first gas separation unit where the raw gas is separated into a hydrogen enriched gas fraction and a and a low hydrogen fraction,
f. introduction of the low hydrogen fraction into the conversion unit to be converted together with the solids therein,
g. Introducing the hydrogen enriched fraction into the second separation unit, wherein the hydrogen enriched fraction and the synthesis gas of step c) are separated in a second light oils fraction, having a boiling range of 100 to 200° C. at atmospheric pressure, and a synthesis gas fraction that is withdrawn through a synthesis gas line,
   the method further comprising:
h. recycling of the first light oils fraction from step d) into the thermolysis and pyrolysis reactor(s).

The post-treatment of the pyrolysis gas produced in the reactor, and the conversion in the conversion unit, are necessary to obtain a sufficient amount of fuel gas having a sufficiently high WOBBE index to be useful for intended purposes, such as to be used as a fuel gas for a gas turbine.

According to one embodiment, the second light oils fraction from step g) is recycled to the thermolysis and pyrolysis reactor(s) together with the first light oils fraction. The second light oil fraction is preferably recycled to reduce or eliminate the presence of such light oils in the produced fuel gas, by exposing the light oils for an additional cycle of thermolysis and pyrolysis.

The first and second light oil fractions are, according to one embodiment, introduced into a cracking unit in which a part of the light oils are cracked, and where the gas resulting from the cracking is separated into a third light oils fraction which is introduced into the thermolysis and pyrolysis reactor(s), and a cracked gas fraction, mainly comprising H, CO and CO₂, that is withdrawn through a cracked gas line and introduced into the first cleaning unit. Introducing the first and second light oils fractions into a cracking unit before recycling of light oils remaining after cracking, is efficient in breaking down the light oils to improve the efficiency of the removal of the light oils by adding an additional step for light oils removal or reduction.

The fuel gas stream in the synthesis gas line is, according to one embodiment, introduced into a CO₂ capture unit to separate at least parts of the CO₂ from the produced fuel gas. By separating at least a part of the CO₂ from the fuel gas, the calorific value, or WOBBE index, of the produced fuel gas is increased. Additionally, capturing of CO₂ results in a reduction of the CO₂ emission from the plant, and capture of CO₂ that can be deposited safely or used as pressure support in oil and gas fields. The rate of CO₂ capture may also be adjusted to allow for adjustment of the WOBBE index to avoid unwanted fluctuation in the WOBBE index.

The conversion in the conversion unit may be controlled to stabilize the WOBBE index of the produced fuel gas steam. The conversion may be adjusted both by adjusting the temperature in the conversion unit, by adjusting the amount of steam introduced into the conversion unit, and by the amount of gas introduced into the conversion unit from the first separation unit.

The method as described above, wherein the incoming waste is fractioned into fractions having different calorific value, and wherein the fractions are remixed in ratios giving a waste input into the thermolysis and pyrolysis reactor that has a substantially stable calorific value. Adjustment of the incoming waste to be treated is an additional way of adjusting the WOBBE index of the resulting gas.

According to one embodiment, the incoming waste is autoclaved before being fractioned. During the process of autoclaving, the waste undergoes different processes that removes the odour from the waste, that reduces the volume of the waste and that makes the sorting process easier, as the different components in the waste gets more separated from each other.

According to a second aspect, the present invention relates to a plant for carrying out the above described process, the plant comprising a waste inlet, thermolysis and pyrolysis reactor(s) for thermal treatment of the waste to produce a pyrolysis gas and a solid rest, a conversion unit for gasification of at least a part of the solid rest from the reactor(s), a first gas cleaning unit for separation of the gas produced in the thermolysis and pyrolysis reactor(s) into a first light oils fraction a light oils recycle line for recycling of the light oils from the first gas cleaning and a scrubbed raw gas line for introduction of the raw gas from the first gas cleaning unit into a gas separation unit, a gas line for introduction of a low hydrogen fraction for the separation unit into the conversion unit, and a hydrogen rich gas line for introduction of a hydrogen rich fraction into a second gas separation unit, a converted gas line for withdrawal of gasified solids from the conversion unit into the second gas separation unit, and a fuel gas line for withdrawal of the produced fuel gas.

According to one embodiment, the plant further comprises a second light oils recycle line for recycling of a second light oils fraction from the second gas separation unit to the reactor(s).

According to one embodiment, the plant further comprises a cracking unit for cracking and separation of the first and second light oil fractions into a third light oil fraction, and a cracked gas fraction, wherein a light oils recycle line is arranged to withdraw the light oils from the cracking unit and introducing the light oils into the reactor(s), and a cracked gas line is provided for withdrawal of the cracked gas from the cracking unit and introduction of the gas into the first gas cleaning unit.

According to a specific embodiment, the plant further comprises a CO₂ capturing unit connected to the fuel gas line for capturing at least a part of the CO₂ present in fuel gas.

According to still another embodiment, the plant further comprising a waste sorting unit for sorting of the incoming waste into fraction having different calorific value, and additionally facilities to remix fractions of the waste to keep a substantially stable calorific value of the input to the thermolysis and pyrolysis reactor.

The plant may additionally comprise an autoclave system for autoclaving the waste before introduction into the sorting unit.

According to one embodiment, the first separation unit is a membrane separation unit. A preferred first separation unit comprises two membranes.

According to yet an embodiment, the second separation unit is a membrane separation unit.

For both the first and second separation units, membrane separation units are preferred, as membrane based separation units for these purposes are known to have relatively low cost, they are reliable, and have low running costs.

### BRIEF DESCRIPTION OF DRAWINGS

FIG. 1 is a flow diagram for a waste handling plant according to the invention,

FIG. 2 is a flow diagram illustrating an embodiment of the present invention in further detail than FIG. 1,

FIG. 3 is a principle drawing of a reactor to be used in the present invention,

FIG. 4 is a principle drawing of a waste sorting system that may be used in the present invention,

FIG. 5 is a flow diagram of an alternative embodiment of the present invention

### DESCRIPTION OF EMBODIMENTS

Throughout the description and claims, the pressure is about ambient pressure, i.e. about atmospheric pressure, if nothing else is specifically stated. Any boiling point and/or boiling ranges indicated are boiling points or boiling ranges at atmospheric pressure, if not specifically defined differently.

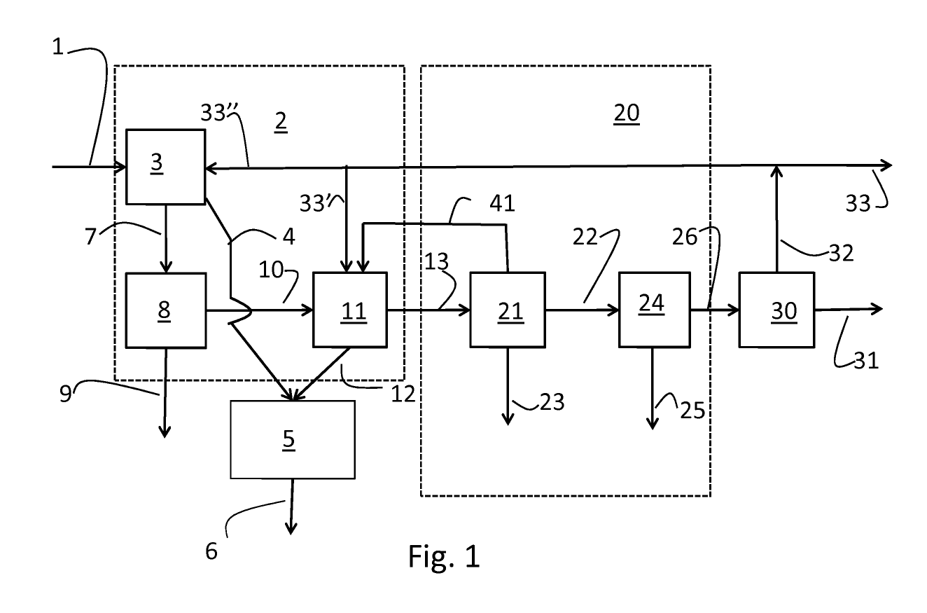

FIG. 1 is an overview illustration of an embodiment of the present invention, where incoming is introduced via a waste line 1, into a waste pre-treatment section 2.

The pre-treatment section of the illustrated embodiment comprises an autoclave system 3, into which the MSW in line 1 is first introduced. Autoclaves suitable for the purpose are delivered i.a. by AeroThermal Group, UK. The autoclave system preferably comprises a series of parallel arranged rotating autoclaves wherein the MSW is treated batch wise. During normal operation the autoclaves will be in different parts of an autoclave cycle, giving a semi-continuous operation.

The autoclave cycle comprises the following steps: Filling MSW into the autoclave, and thereafter closing the autoclave. Closing and then evacuating the autoclave to remove most of the air from the inside of the autoclave. Introduction of steam into the autoclave to heat the autoclave and its content to about 160° C. typical at about 5,2 barg (bar gauge). Keeping the temperature and pressure for a predetermined period, such as e.g. 30-40 minutes. The autoclaves are rotated during this process.

During the autoclaving process, the MSW in the autoclave is sanitized, and the volume is typically reduced by about 60%. The heat treatment kills all the bacteria and other degrading life in the MSW, and thus removes the odour of the waste. Plastics, such as PE and PET, reach their glass-rubber transition stage and are reduced through deformation. Plastic films are mostly unaffected by the autoclaving but are cleaned during the process cycle. Grass cuttings and small yard waste are reduced to cellulose fibres. Additionally, lignin and other macromolecules are broken down, and/or coagulated. The autoclaving process thus reduces bonds between parts of the MSW and makes the further processing easier.

After finalization of the heat treatment, the autoclave is vented and the steam therein is introduced to a condenser, where the steam is condensed to give water. The water is withdrawn through a waste water line 4 and is introduced into a waste water treatment unit 5 treated before being released or re-used, to avoid pollution to the surroundings or to avoid accumulation of pollutants in water circulating in the plant. Treated waste water is withdrawn through a treated water line 6 to be released, further treated or re-used.

The autoclave is then again filled to restart the autoclave cycle. To obtain a semi-continuous process, the cycles of the autoclaves in parallel, are controlled so that they are out of phase which each other.

The autoclaved MSW is thereafter taken out of the autoclaves 3 through autoclaved waste lines 7 and introduced into a sorting system 8 comprising a set of conveyors and sorting devices, separating the autoclaved MSW into different fractions. The sorting system is preferably a state of the art sorting system for separating the incoming MSW in a plurality of fractions, such as plants marketed and delivered by Stadler Anlagenbau GmbH, Germany.

In such a sorting plant the MSW is sorted into fractions such as:
PET (polyethylene terephthalate)
HDPE (high density poly ethylene)
Mixed plastics, that may be sorted in individual fractions
Films
Tetrapacks
Mixed paper
SRF (solid recovered fuel)
Non-ferrous metals
Ferrous metals
Residues (non-combustible solid residue)

Plastics rich in nitrogen or chlorine are unwanted in most of the potential uses for the fuel produced according to the invention. Nylon, which primarily is contained in carpets, contains nitrogen, and result in formation of NOx in a plant for combustion, whereas PVC produces HCl, which is strongly acidic in combination with water. Additionally, both nylon and PVC may be sold as valuable products for recirculation. Separation of nylon and PVC from the remaining plastics may be performed by means of computer operated wind sifting in combination with near infra red detection, as further described below. A minor amount of Nylon and/or PVC are, however, acceptable as a contamination to the different fractions. PVC may by be used, provided that the weight of PVC amounts to less than 1% by weight of the total MSW.

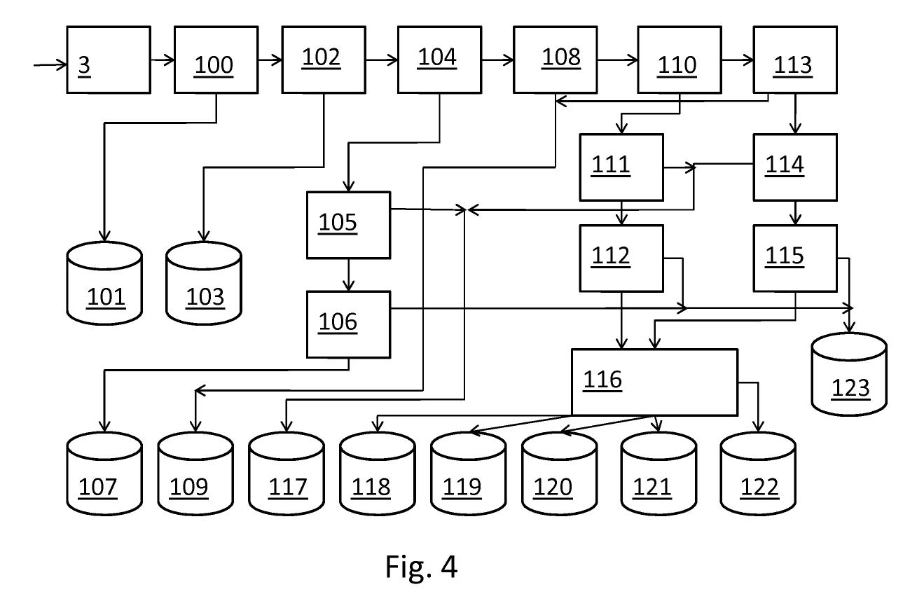

FIG. 4 illustrates a typical flow diagram for a sorting plant. The waste enters the plant, as above described, through the waste line 1 and is introduced into the autoclave 3. The autoclaved waste is withdrawn from the autoclave 3 and introduced via line 7 into a first magnetic separator 100 which catches big ferrous pieces, that are present in the autoclaved waste material, and removes it from the remaining waste, into a first iron fraction 101.

After leaving the first magnetic separator, the waste is further sorted in a first screen 102, such as a finger screen, dimensioned to remove large items, such as items having a size >200 mm and stringy materials like wrapping foils, textile and rope, by allowing particle of <200 mm through the screen. The >200 mm fraction is collected in a large high calorific value fraction 103. The skilled person will understand that what is regarded as a large item in such a plant is dependent on the actual plant and that the given limit of 200 mm may differ from plant to plant. If deemed necessary, a sorting unit comprising a near infrared detection system may be arranged to remove any nylon and/or PVC from said fraction.

The <200 mm material passing through the first screen 102, is thereafter screened in a second screen 104, such as a Starscreen®, to give a <12 mm fraction, and a +12 mm fraction. The <12 mm fraction is introduced into a magnetic drum over belt separator 106, to separate a iron containing waste fraction that is combined with other iron containing fractions as will be described below. The non-ferrous fraction not being removed in the separator 106, is introduced into a non-ferrous separator 106, where the components are separated based on their density to give a non-ferrous heavy fraction that is combined with other non-ferrous heavy fractions as described in more details below. The lighter material is collected in a flock/fibre fraction 107.

The +12 mm fraction is introduced into a first wind sifting separator 108, where most of the less dense material is separated from the denser material by means of blowing air and gravity. Light materials, mostly comprising plastics in addition to some additional light materials are led into a light materials fraction 109. The light material fraction may be further sorted to separate different plastic and/or to separate plastic from non-plastic material.

The dense fraction from the first wind sifting separator 108 is introduced into a screening unit 110 separating material according to size, i.e. <50 mm and >50 mm. The <50 mm material is introduced into a magnetic drum over belt separator 111, to separate a ferrous fraction that is handled as described below, and a non-ferrous fraction that is introduced into a non-ferrous separator, separating the dense material, typically metals, from less denser materials. The dense material is collected as described below, whereas the less dense material is introduces into a near infrared detection separator section 116 as will be described below.

The >50 mm material from the screening unit 110, is introduced into a second wind sifting separator 113. The less dense material from the second wind sifting separator 113 is combined with the less dense material from the first wind sifting separator 108, as described above. The dense material from the second wind sifting separator 113 is introduced into a magnetic drum over belt separator 114, to give a ferrous fraction that is combined with the ferrous material from the separators 105 and 111 as described above, and introduced into a ferrous fraction 117.

The non-ferrous fraction from separator 114 is introduced into a non-ferrous separator 115, corresponding to separators 106 and 112, to give a dense fraction that is combined with the corresponding fractions from separators 106 and 112 and collected as a non-ferrous fraction 123.

The near infrared separator section 116 typically comprises several corresponding separators, optionally with a ferrous separator for a final separation of ferrous materials from the remaining waste. The infrared separators, e.g. four separators, are all corresponding separators that are adjusted for separation of different types of plastic materials. The skilled person understands how to adjust the detectors for separation of the different plastic types, based on their chemical composition that is detectable using near infrared detectors.

The near infrared separator section 116 may, if it comprises four infrared separators as indicated below, will be able to separate the introduced material into fractions as PCV in a fraction 118, nylon in a fraction 119, PET in to a fraction 120, mixed plastics into a fraction 121, a high calorific end product fraction 122, and optionally an additionally not shown metal fraction.

Recyclable materials such as the ferrous fraction 101, 117, the non-ferrous fraction 123, the PVC fraction 118 and nylon fraction 119, are exported from the plant. The PVC fraction 118 may, however, be used internally for fuel gas generation, provided that the PVC amounts to less than about 1% by weight of the total sorted MSW added. Even other fractions, such as the PET fraction 120 may be exported if all PET is not needed for the gas production.

Non-recyclable and combustible waste fractions are withdrawn from the sorting plant, even though the export lines are not illustrated in FIG. 4. The non-recyclables are introduced into a humidity adjustment unit 11 via a non-recyclables line 10.

The skilled person understands that the size limits given for the fractions above are examples, and that the size limits may differ substantially depending on the supplier of the plant and the concrete plans for a new plant. The number of fractions and the sequence of the different sorting processes may also differ. Additionally, fractions that are not sufficiently homogenous after sorting, may be recycled to an earlier sorting step.

A normal MSW has normally a humidity of about 20 to 30% by weight. After autoclaving the humidity has normally increased to about 50% by weight. The humidity required for further treatment in normally from about 10 to 25% by weight, such as from 15 to 20% by weight, e.g. about 18% by weight. Accordingly, the humidity of the waste normally has to be dried. If the waste is too dry, water and/or steam are added to humidify the waste. Any excess water is removed from the humidity controlling unit 11 through excess water line 12 and introduced into the waste water treatment unit 5, as described above. Alternatively, water and/or steam may be added through not shown line(s).

Drying of the MSW may be obtained by blowing air through the MSW, or by heating the MSW, or a combination thereof. Heat for drying of the non-recyclables in the humidity adjustment unit 11, may come from hot water/steam generated in a later described gas turbine power plant 30, and/or by firing of combustible gas produced later gas producing units, in a combustion chamber arranged for heating of the material to be dried.

The skilled person will understand that the described pre-treatment section 2 is a presently preferred pre-treatment section and that any pre-treatment unit that can produce a sorted and fractionated waste may replace the described unit without leaving the scope of the invention. Alternative pre-treatment sections may be shredder type waste treatment plants, etc.

From the humidity adjustment unit 11, the sorted and humidity adjusted waste is withdrawn through a pre-treated waste line 13 to be introduced into a gas production and treatment section 20. The pre-treated waste is via the pre-treated waste line 13 introduced into a pyrolysis and thermolysis unit 21, for production of a synthesis gas, mainly comprising hydrogen, CO and CO₂, that is withdrawn through a fuel gas line 22 for the intended use, and a solid rest, mostly comprising carbon, that is withdrawn in line 23, that is exported from the plant for further use or deposition. The pyrolysis and thermolysis unit 21 will be further described below.

The skilled person will understand that if the waste is too dry, water and/or steam may be introduced into waste when the waste is feed into the reactor 21 in addition to or in lieu of adding water and/or steam in a separate humidity adjustment unit.

The synthesis gas withdrawn from in line 22 may be used as it is, or be introduced into an optional separation unit 24, for separation, or capturing of CO₂ from the synthesis gas. In the second separation unit, the incoming synthesis gas is separated, to produce a CO₂ stream that is withdrawn through a CO₂ export line 25, and a low CO₂ synthesis gas, that is withdrawn through a low CO₂ fuel gas line 26. The second separation unit 21 may be of any well known type, such as an absorption/desorption unit, pressure swing unit, or a membrane based unit. The presently preferred CO₂ capture unit is a membrane based unit, due to its low running costs. Such solutions are commercially available.

CO₂ from the CO₂ capture unit and exported through a CO₂ export line 25 may be sent to a carbon storage facility to store the CO₂ in a depleted oil or gas well, or in an aquifer in a well known way, or be sold for use for pressure support in enhance oil recovery. Alternatively, the captured CO₂ or parts thereof, may be used for agricultural or aquaculture purposes, and be introduced into greenhouses or plants for algae production as a source of carbon.

The gas produced in the thermolysis and pyrolysis unit 21 have many potential uses. In the illustrated embodiment, the gas is introduced into a gas turbine after being passed through the CO₂ capture unit 24. The gas may, optionally, be sent for its final use, such as e.g. a gas turbine, without CO₂ capture, depending on the intended use. For most purposes, the CO₂ present in the gas in line 22 is an inert gas that reduces the calorific value of the gas, and increases the volume of the gas. Both from such a technical viewpoint, and from an environmental viewpoint, it is therefore an advantage to capture CO₂, before using or selling the produced gas. By capturing CO₂, the CO₂ footprint of the plant is substantially reduced.

In the illustrated embodiment, the produced gas leaving the gas production and treatment unit 20 in line 26, is introduced into a gas turbine plant 30, to produce electrical power that may be used for internal processes requiring electrical power, and where the surplus electric energy may be sold to the electric grid through an electric power line 31.

Steam produced in the gas turbine plant 30, is withdrawn through a steam line 32, to deliver hot water and/or steam to heat requiring processes in the plant, such as the autoclaves, 3, and drying in the humidity adjusting unit 11 via internal steam lines 33′, 33″. The skilled person will also be able to identify other possible internal consumers of the heat energy in the hot water or steam. Excess heat in form of steam and/or hot water may be exported from the plant for e.g. district heating through steam export line 33.

According to an alternative embodiment, the gas turbine 30 is substituted with a Fischer-Tropch (FT) plant, for conversion of the synthesis gas to synthetic hydrocarbons in a well known way.

The skilled person will understand that the present gas production and treatment unit 20 may be used for other hydrocarbon rich materials than MSW, such as e.g. more homogenous waste materials as waste plastic materials such as agricultural plastic waste, or tyres. Such materials have humidity that is too low for efficient thermolysis and pyrolysis in unit 21. Water may be added to such types of waste in the humidity adjustment unit 11 and/or be added into the thermolysis and pyrolysis unit 21 through a not shown water introduction line, to give water content in unit 21 of about 20% by weight of the introduced waste.

The solids withdrawn from the thermolysis and pyrolysis unit 21 through line 22, may differ in composition and potential use based on the incoming waste. One potential use for the solid rest, withdrawn through line 22, is for soil improvement, by spreading the material on farmland.

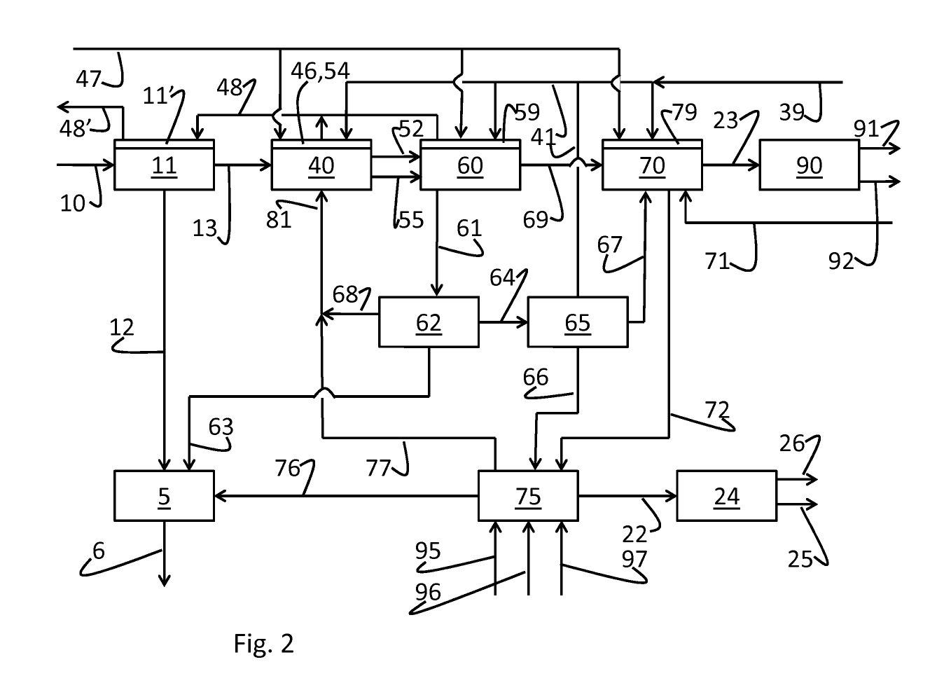

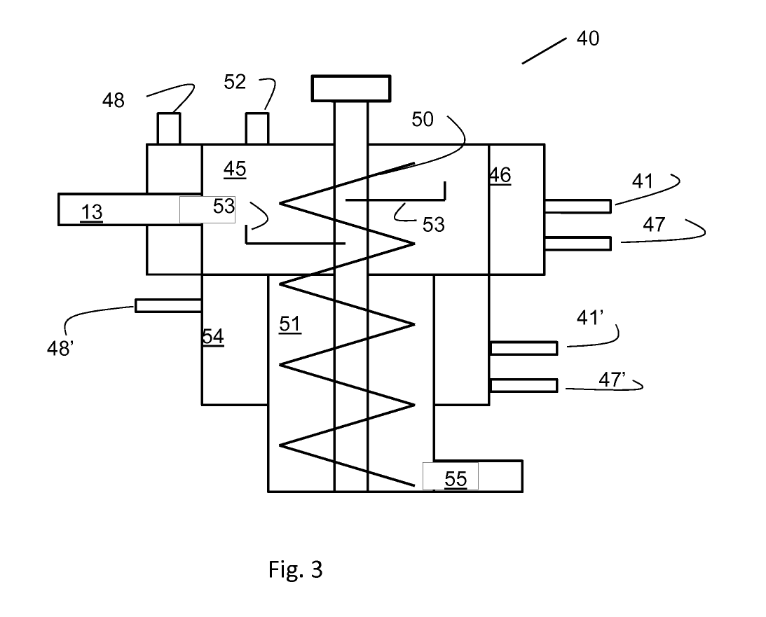

FIG. 2 is an illustration one embodiment of the gas production and treatment unit 20, but includes also the humidity controlling unit 11, and FIG. 3 is a principle sketch of a reactor 40, being a central part of the treatment unit 20.

Waste is introduced into the humidity controlling unit 11, here illustrated as a drying unit, through waste line 10 as described above. Heat for drying the waste in the humidity controlling unit 11 may supplied to a heating chamber 11′, as steam through line 33′, or as hot flue gas in flue gas line 48 from sources that will be further explained below. After being cooled while heating and drying the waste, the cooled exhaust is released through an exhaust gas release line 48′.

From the humidity controlling unit 11, the waste is introduced into a primary reactor 40 via a humidified waste line 13, and introduced into a primary reactor 40, e.g. of the kind described in the above indentified EP1160307 A. The skilled person will understand that the illustrated reactor 40 may be one reactor or two or more reactors arranged in parallel. The same applies to all elements described below.

Waste from the humidity control unit 11 is introduced into the primary reactor 40 through the waste line 13 into a mixing chamber 45 surrounded by a heating jacket 46 heated by combustion of heating gas introduced through a heating gas line 41 and air that is introduced through an air line 47. Exhaust gas from the combustion is withdrawn through an exhaust release line 48.

A screw conveyor 50, operated by means of a motor 49, is arranged in the mixing chamber 45, the screw conveyor extending 50 into a high temperature chamber 51. Optional mixing arms 53 may be connected to the axis of the screw conveyor, for mixing of the incoming waste with waste already partly processed in the mixing chamber.

The waste mixture in the mixing chamber is transported into the high temperature chamber 51 by means of the screw conveyor 50. In the high temperature chamber 51 the waste is further heated by means of combustion of heating gas in heating jacket 54, surrounding the high temperature chamber 51. Heating gas is introduced into the heating jacket 54 through a gas line 41′, and air for the combustion is introduced through an air line 47′. A gas line 41′ is provided to add natural gas into line 41 during start-up of the plant.

The total waste in the mixing chamber 45 and high temperature chamber 51 is thus heated in absence of oxygen to effect thermolysis and pyrolysis therein. The waste in the mixing chamber is heated both by the heating jacket 46 and pyrolysis and thermolysis gases generated in the mixing chamber and the high temperature chamber. At least a part of the gases generated through pyrolysis and thermolysis in the mixing chamber and high temperature chamber is withdrawn through a pyrolysis gas line 52 connected to the mixing chamber. The temperature in the mixing chamber is typically from 500 to 700° C., whereas the temperature in the high temperature chamber is higher due to the additional heating, such as typically about 1000° C. The pressure in the reactor 40 is typically about ambient pressure or slightly higher.

Due to the thermolysis and pyrolysis in the reactor 40, a substantial part of the original mass of the waste is converted to gas by well known thermolysis or pyrolysis reactions. Small and large organic molecules such as synthetic or natural polymers or macromolecules, such as carbohydrates, fats, proteins, plastics etc., are thermally cracked, i.e. molecules are split via different reactions to form smaller molecules. The humidity present in the waste, and/or water/steam added into the waste during introduction into the mixing chamber results in some steam cracking reactions to happen in the reactor as well as heat cracking. Due to the presence of water in the reactor 40, several reactions take place therein. First of all, the temperature causes thermolysis or pyrolysis of the hydrocarbon material introduced into the reactor, to give a solid char rest and gases, primarily hydrogen, methane, minor amount of lower hydrocarbons and tars, or higher hydrocarbons that will condensate at lower temperatures. Additionally, the water present in the reaction mixture in the reactor 50, will react with carbon according to the reactions:

C+H₂O⇄CO+H₂ (gasification reaction) (1)

CO+H₂O⇄CO₂+H₂ (water gas shift reaction) (2)

As mentioned above, a part of the generated gas may be withdrawn through line 52, as will be described in further detail below. The remaining mass of solid waste is withdrawn from the bottom part of the high temperature chamber 51 through a high temperature chamber outlet 55 and are directly introduced into a series of secondary reactors 60, here illustrated by one reactor 60. The gas withdrawn trough line 52 is introduced into the first secondary reactor 60, to participate in the further breakdown of hydrocarbons in the secondary reactor 60.

The secondary reactor(s) 60 have a common design being tubular reactor(s), provided with a screw conveyor both for mixing the solid material and the gas, and for carrying the remaining solid material through the reactor(s). Additionally, the reactors are provided a heating jacket 59 heated by combustion as for the primary reactor 40, for further pyrolysis and thermolysis of the remaining solid waste, and to ascertain that generated gas is released from the solid waste therein. The temperature in the secondary reactors is upheld at about the same temperature as in the high temperature chamber. Dependent on the specific plant, two or more secondary reactors 60 may be serially connected to provide maximum thermolysis and pyrolysis of the waste. The solid rest from the last secondary reactor 60 is withdrawn through a solids line 69 and is introduced into a conversion unit 70.

Gases generated and/or released from the solid carbonized waste, are withdrawn from the secondary reactors 60 through a raw gas withdrawal line 61, and are introduced into a first gas cleaning unit 62. The first gas cleaning unit 62 is provided for removal of tars, oils and dust particles from the raw gas stream. The first cleaning unit 62 comprises a series of scrubbers where the gas is washed in a buffered liquid medium. The first cleaning unit may be of the kind described in EP 1316351 A2 (DR. ANDREAS UNGER) Apr. 6, 2003 The temperature of the raw gas is reduced in stages, from one scrubber to the next, to separate the condensate, and solid particles from the gas. The temperature, pH and composition of the scrubbing media are controlled in a conventional way.

Waste water from the scrubbers is removed from the first gas cleaning unit 62 through a waste water line 63 and is introduced into the above mentioned waste water treatment unit 5.

Scrubbed raw gas, mainly comprising CO, CO₂ and hydrocarbons having a boiling range below 170° C., is removed from the first gas cleaning unit 62 via a scrubbed raw gas line 64 and introduced into a gas separation unit 65 comprising two membrane based separation units, one membrane unit to give a hydrogen enriched gas fraction that is withdrawn through a hydrogen rich gas line 66, and one membrane unit to give a hydrocarbon rich fraction that is withdrawn through a heat gas line 41, to be used for firing for heat purposes as described above and a third raw gas fraction comprising a mixture of gases, mainly lower hydrocarbons, CO, CO₂, and some hydrogen, that is withdrawn through a gas line 67. The gas in line 67 is introduced into the above mentioned conversion unit 70.

The solids introduced into the conversion unit 70 in line 69, are heated by combustion of heat gas in a heating jacket 79 and is reacted with the gas introduced through line 67, and steam introduced through a steam line 71 to further break down hydrocarbons in the gas, and for gasification of carbon in the solids, according to the “gasification” reaction: H₂O+C⇄Co+H₂ to add additional synthesis gas to the generated gas flow. Dependent on the amount of steam introduced through the steam line 71, the generated CO may be further converted to CO₂ and hydrogen, by the reaction CO+H₂O⇄CO₂+H₂.

The conversion in the conversion unit 70 does, however, result in a higher concentration of hydrogen in the product gas, at the cost of gas used for heating the conversion unit 70.

Gas generated in the conversion unit 70 is withdrawn through a converted gas line 72, and is introduced into a second gas cleaning unit 75, were the gas the gas is combined with the gas in the above described hydrogen rich gas line 66, and is scrubbed in a series of scrubbers, where the calcium hydroxide or sulphuric acid, and/or other chemicals, such as Ca(OH)₂, and sulphuric acid, used for removal of unwanted elements in the gas, may be included in the scrubbing solution. Water for scrubbing, and aqueous solutions of scrubbing chemicals are added through supply lines 95, 96 and 97, respectively. Used scrubbing solution is removed through a used water line 76 and introduced into the waste water unit 5.

The solid waste from the converter 70 is withdrawn through a solids waste line 23 and is optionally introduced into a char handling unit 90, where the solid material is separated into char, that is withdrawn through a char line 91, and a mixture of char and ash that is withdrawn through an ash line 92. The char and ash are exported for the plant, and sold/deposed.

Heating gas for heating jackets 46, 54, 59, 70 is introduced through lines 41 as described above. During normal operation the heating gas is withdrawn from the gas separation unit 65 as described above. Start up heating gas for starting up the plant, or supplementary gas in the case that the heating gas withdrawn from the gas separation has to be supplemented to give the required heating, may be introduced through a start up gas line 39. Oxidant, such as air, or other gas including oxygen, to obtain combustion and generation of heat in the heating jackets by combusting the heating gas, is added through the air line 47.

A first light oil fraction having a boiling range from about 170-350° C. at atmospheric pressure is withdrawn from the first gas cleaning unit 62 via a first light oil line 68, and introduced into a light oil recycle line 81 for introduction of light oils into the primary reactor 40. A second light oils fraction having a boiling range from about 100-200° C. at atmospheric pressure is withdrawn from the second gas cleaning unit 75 through a second light oil line 77, and is also introduced into the light oils recycle line 81. The light oil fractions that are recycled into the primary reactor participates in the reactions in the primary reactor 40 and are further broken down as described above.

Raw fuel gas is withdrawn through the synthesis gas line 22 and may be introduced into the CO₂ separation unit 24 for removal of a substantial part of the CO₂ from the gas as described above, as described above.

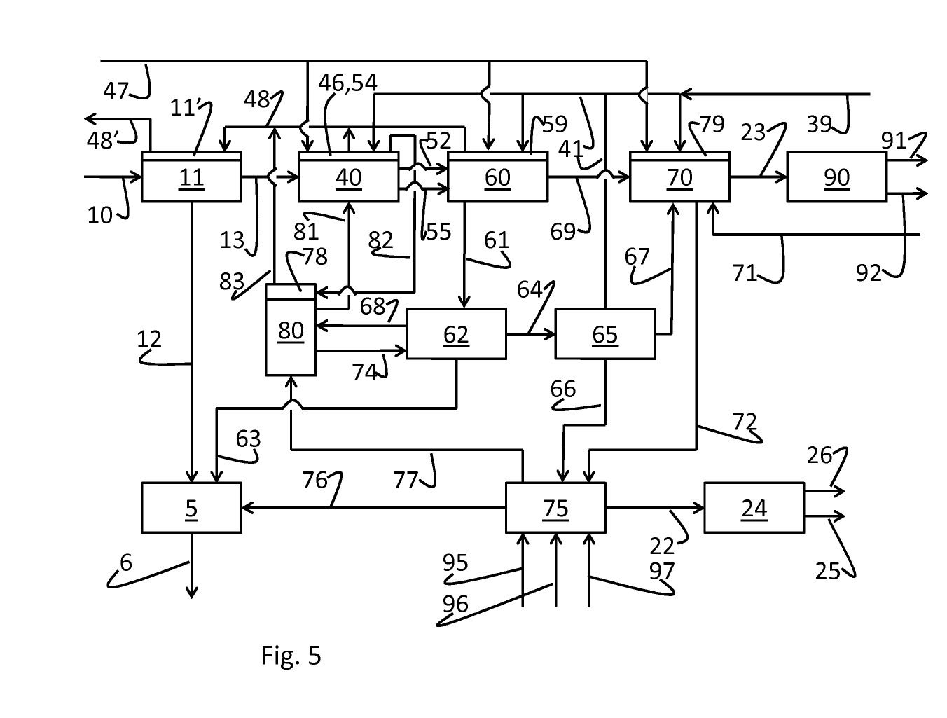

FIG. 5 illustrates a specific embodiment of the present invention where a cracking unit 80 is arranged for receiving and cracking the first and the second light oil fractions in lines 68 and 76. In the cracking unit 80, the hydrocarbons are thermally cracked by heating the cracking unit with exhaust gas from the heating collars 46, 54 from the primary reactor 40 that is withdrawn through an exhaust gas line 82 and introduced into a heating collar 78 surrounding the cracking unit 80. The spent exhaust gas from the heating collar 78 is returned into the above described exhaust line 48 through an exhaust gas return line 83.

The light oil fraction is thermally cracked in the cracking unit to produce synthesis gas, mainly comprising hydrogen, CO and CO₂. The cracking in the cracking unit is not complete. The light oils that are not cracked in the cracking unit are withdrawn through a light oils recycle line 81, to be recycled into the primary reactor as above described.

The synthesis gas generated in the cracking unit 80 is withdrawn through a cracked gas line 74 and introduced into the first gas washing section 62 as a part of the gas to be washed and separated therein.

Table 1 below gives typical values for kind of matter, mass flow, temperature and pressure in different lines in an exemplary waste handling plant according to the embodiment of present invention illustrated in FIG. 5, for handling of MSW, where the resulting gas is intended for a gas turbine for generation of electric power and district heating and/or cooling.

TABLE 1

| Material in the | | | | Pressure |
|---|---|---|---|---|
| flow | Line No. | Mass (kg/h) | Temp (°) | (mbar) |
| Incoming | 10 | 14000 | 20 | — |
| MSW | | | | |
| Dried MSW | 13 | 13200 | 100 | — |
| CO₂/fuel gas | 22 | 7600 | 800 | 50 |
| CO₂ | 25 | 3300 | | |
| Fuel gas | 26 | 4300 | | |
| Raw gas | 61 | 12800 | 800 | 50 |
| Heating gas | 41 | 3800 | | |
| Char | 91 | 1400 | | |
| Ash/char | 92 | 1400 | | |

It can inter alia be seen from the table, that the total mass is reduced by about 80% by weight. The amount of solids is i.a. dependent on the conversion in the conversion unit 70, as the weight of the carbonaceous rest may be substantially reduced by conversion of carbon by the gasification reaction mentioned above. In addition to this substantial reduction of weight, and correspondingly, volume, the solid material exported from the plant has valuable properties making it possible to sell the product at the marketplace. The solid waste may be used in agriculture for soil improvement, and/or find use in different industrial applications. If there is no marked for the solid waste, it may be safely deposed, which is not the case for the MSW before treatment.

The input waste in line 10 may vary over time, a variation that may influence on the WOBBE index. Stabilization of the WOBBE index may be accomplished by one or more measures, such as limiting the in-homogenous feed stock into the gas production and treatment unit 20 through line 13, adjusting the humidity of the feed stock in line 13, adjusting the conversion severity in the conversion unit 70 to influence the ratio of hydrogen to CO to CO₂ produced therein, actively controlling the CO₂ capture in the CO₂ capture unit 24, and adjusting the cracking severity of light oils in the cracking unit 80.

The present invention is described with reference to a specific plant and a specific embodiment. The skilled person will know how to adjust the parameters, dependent on the incoming waste, to obtain a fuel gas in line 26 that is suitable for other uses than for a gas turbine according to the state of the art. The fuel gas in line 26 comprises a mixture of CO, hydrogen, CO₂, and lower hydrocarbons, such as methane, ethane, propane and butane. The produced fuel gas may be further separated to give individual fractions of one, two or more of the gases in the mixture. The gasification and thermolysis unit may also be operated at a higher temperature, and/or by introduction of more steam to cause more steam reforming to shift the products further against hydrogen and CO₂

It is assumed that gas turbines that can accept relatively pure hydrogen as fuel will be available within a few years. The skilled person will know how to adjust the parameters in different parts of the plant to obtain a produced gas in line 26 that mainly comprises hydrogen at the expense of CO, which has a far lower calorific value than hydrogen.

Correspondingly, the skilled person will understand how to adjust the parameters of operation of the plant if the intended use for the fuel gas produced is to produce other products from the fuel gas, instead of generating electrical power and hot water for district heating and/or cooling. The plant will then be adjusted to produce a fuel gas mixture that is optimal for the intended purpose, such as fuel gas for a Fischer Tropsch plant for synthesis of higher hydrocarbons.

### REFERENCES

EP 1160307 A (KUNSTSTOFF-UND UMWELTSTECHNIK GMBH) May 12, 2001

EP 1316351 A (DR. ANDREAS UNGER) Apr. 6, 2003

1. A method for thermal treatment and chemical transformation of waste comprising natural and synthetic carbonaceous materials for generation of a fuel gas for further use, the method comprising the following steps:
a. adjusting the humidity of the carbonaceous materials to a predetermined level by drying or introduction of water or steam into the carbonaceous material,
b. introduction of the humidified carbonaceous material into thermolysis and pyrolysis reactor(s), in which the materials are thermally treated to produce a raw pyrolysis and thermolysis gas and a carbonaceous solid rest,
c. introduction of the carbonaceous solid rest from step b) and steam into a conversion unit to cause partial gasification of solid carbonaceous material therein to produce a synthesis gas comprising hydrogen, CO and CO₂ that is withdrawn and introduced into a second scrubbing section and a solid rest that is withdrawn for further treatment or disposal,
d. introducing the raw thermolysis and pyrolysis gas from step b) into a first gas cleaning unit where the gas is separated into a first light oil fraction having a boiling range from 170 to 350° C. at atmospheric pressure, and a scrubbed raw gas fraction mainly comprising H, CO, CO₂ and hydrocarbons having a boiling range below 170° C.,
e. introducing the scrubbed raw gas fraction into a first gas separation unit where the raw gas is separated into a hydrogen enriched gas fraction and a and a low hydrogen fraction,
f. introduction of the low hydrogen fraction into the conversion unit to be converted together with the solids therein,
g. introducing the hydrogen enriched fraction into the second separation unit, wherein the hydrogen enriched fraction and the synthesis gas of step c) are separated in a second light oils fraction, having a boiling range of 100 to 200° C. at atmospheric pressure, and a synthesis gas fraction that is withdrawn through a synthesis gas line
wherein the method further comprises
h. recycling of the first light oils fraction from step d) into the thermolysis and pyrolysis reactor(s).

2. The method of claim 1, wherein the second light oils fraction from step g) is recycled to the thermolysis and pyrolysis reactor(s) together with the first light oils fraction.

3. The method of claim 1, wherein the first and second light oil fractions are introduced into a cracking unit in which a part of the light oils are cracked, and where the gas resulting from the cracking is separated into a third light oils fraction which is introduced into the thermolysis and pyrolysis reactor(s), and a cracked gas fraction, mainly comprising H, CO and CO₂, that is withdrawn through a cracked gas line and introduced into the first cleaning unit.

4. The method of claim 1, wherein the fuel gas stream in the synthesis gas line is introduced into a CO₂ capture unit to separate at least parts of the CO₂ from the produced fuel gas.

5. The method of claim 1, wherein the incoming waste is fractioned into fractions having different calorific value, and wherein the fractions are remixed in ratios giving a waste input into the thermolysis and pyrolysis reactor that has a substantially stable calorific value.

6. The method of claim 5, wherein the incoming waste is autoclaved before being fractioned.

7. The method according to claim 1, wherein the method additionally comprises introduction of the produced fuel gas into a gas turbine power plant for production of electrical power.

8. A plant for carrying out the process of claim 1, the plant comprising a waste inlet, thermolysis and pyrolysis reactor(s) for thermal treatment of the waste to produce a pyrolysis gas and a solid rest, a conversion unit for gasification of at least a part of the solid rest from the reactor(s), a first gas cleaning unit for separation of the gas produced in the thermolysis and pyrolysis reactor(s) into a first light oils fraction, a light oils recycle line for recycling of the light oils from the first gas cleaning and a scrubbed raw gas line for introduction of the raw gas from the first gas cleaning unit into a gas separation unit, a gas line for introduction of a low hydrogen fraction for the separation unit into the conversion unit, and a hydrogen rich gas line for introduction of a hydrogen rich fraction into a second gas separation unit unit, a converted gas line for withdrawal of gasified solids from the conversion unit into the second gas separation unit, and a fuel gas line for withdrawal of the produced fuel gas.

9. The plant according to claim 8, wherein a second light oils recycle line for recycling of a second light oils fraction from the second gas separation unit to the reactor(s).

10. The plant according to claim 8, wherein the plant further comprises a cracking unit for cracking and separation of the first and second light oil fractions into a third light oil fraction, and a cracked gas fraction, wherein a light oils recycle line is arranged to withdraw the light oils from the cracking unit and introducing the light oils into the reactor(s), and a cracked gas line is provided for withdrawal of the cracked gas from the cracking unit and introduction of the gas into the first gas cleaning unit.

11. The plant according to claim 8, wherein the plant further comprises a CO₂ capturing unit connected to the fuel gas line for capturing at least a part of the CO₂ present in fuel gas.

12. The plant according to claim 8, further comprising a waste sorting unit for sorting of the incoming waste into fraction having different calorific value, and additionally facilities to remix fractions of the waste to keep a substantially stable calorific value of the input to the thermolysis and pyrolysis reactor.

13. The plant according to claim 12, wherein the plant additionally comprises an autoclave system for autoclaving the waste before introduction into the sorting unit.

14. The plant according to claim 8, wherein the plant additionally comprises a gas turbine fired by the fuel gas, for generation of electrical power.

15. The plant according to claim 8, wherein the first separation unit is a membrane separation unit.

16. The plant according to claim 15, wherein the first separation unit comprises two membranes.

17. The plant according to claim 8, wherein the second separation unit is a membrane separation unit.
